(19) United States
(12) Patent Application Publication
(10) Pub. No.: US 2014/0152783 A1
(43) Pub. Date: Jun. 5, 2014

(54) DISPLAY DEVICE

(71) Applicants: Kei Oyobe, Osaka-shi (JP); Toshihiro Yanagi, Osaka-shi (JP); Ryoh Araki, Osaka-shi (JP); Shigenori Tanaka, Osaka-shi (JP); Yoshinobu Hirayama, Osaka-shi (JP); Kryoshi Nakagawa, Osaka-shi (JP)

(72) Inventors: Kei Oyobe, Osaka-shi (JP); Toshihiro Yanagi, Osaka-shi (JP); Ryoh Araki, Osaka-shi (JP); Shigenori Tanaka, Osaka-shi (JP); Yoshinobu Hirayama, Osaka-shi (JP); Kryoshi Nakagawa, Osaka-shi (JP)

(73) Assignee: SHARP KABUSHIKI KAISHA, Osaka-shi, Osaka (JP)

(21) Appl. No.: 14/232,962

(22) PCT Filed: Aug. 29, 2012
(86) PCT No.: PCT/JP2012/071908

§ 371 Date: Jan. 15, 2014

(30) Foreign Application Priority Data
Sep. 1, 2011 (JP) 2011-19114

(51) Int. Cl. H04N 13/04; G02B 27/22

(52) U.S. Cl. CPC H04N 13/04; G02B 27/2214
USPC 348/51

(57) ABSTRACT

The display device (1) displays, based on at least information indicative of a visual line direction (20) of an observer (2), a three-dimensional video image (18) which (i) varies depending on the visual line direction (20) and (ii) is directing to the observer (2). The observer (2) can view the three-dimensional video image (18) of a three-dimensional object from various angles as if the observer (2) viewed the actual three-dimensional object from various angles.

### TECHNICAL FIELD

The present invention relates to a display device which displays a three-dimensional video image which is stereoscopically viewable.

### BACKGROUND ART

In recent years, a display device, capable of displaying a three-dimensional video image which is stereoscopically viewable to an observer, has been widespread. Recently, a television and a game machine, each of which includes such a display device, have been widely accepted by consumers as new value-added products.

In order for an observer to stereoscopically view a three-dimensional video image, a parallax direction of the observer needs to coincide with that of the three-dimensional video image. According to a conventional three-dimensional video image display device, the parallax direction of the three-dimensional video image is always fixed. Accordingly, only in a case where the observer fixes his/her head, the observer can stereoscopically view a three-dimensional video image in a stable manner.

In a case where the observer (i) widely moves the head or (ii) inclines the head obliquely to a screen, the parallax direction of the observer and that of the three-dimensional video image do not coincide with each other. This causes a great deterioration in quality of the three-dimensional video image to be displayed. For example, the observer may not be able to stereoscopically view the three-dimensional video image in a proper manner or a crosstalk of the three-dimensional video image can occur. In view of the circumstances, some conventional techniques for attempting to address such problems have been developed.

Patent Literature 1 discloses a head position following stereoscopic image display device which suitably adjusts a timing at which a left-eye display video image and a right-eye display video image, for example, are switched so that the observer less recognizes moire or crosstalk which occurs at the time of the switching.

Patent Literature 2 discloses a virtual space presentation device including (i) distant view presentation means for presenting a distant view video image having a wide visual field and (ii) close view video image means, worn on the head of the observer, for presenting a close view video image.

Patent Literature 3 discloses an immersive display device which displays, on a composite information display section, two-dimensional information as a two-dimensional video image which does not need to be stereoscopically viewed, even in a case where an operation is carried out, in a virtual world, by use of a two-dimensional object such as a word processor document, a drawing, and a photograph.

### CITATION LIST

### Patent Literatures

Patent Literature 1

Japanese Patent Application Publication, Tokugan, No. 2003-107392 A (Publication Date: Apr. 9, 2003)

Patent Literature 2

Japanese Patent Application Publication, Tokukai, No. 2002-290991 A (Publication Date: Oct. 4, 2002)

Patent Literature 3

Japanese Patent Application Publication, Tokukai, No. 2003-141573 A (Publication Date: May 16, 2003)

### SUMMARY OF INVENTION

### Technical Problem

The technique disclosed in Patent Literature 1 can expand, in a parallax direction of a video image, a range in which the video image is stereoscopically viewed. However, since the parallax direction of the video image is always fixed, the range, in which the video image is stereoscopically viewed, cannot be expanded in a direction other than the parallax direction of the video image. Accordingly, even in a case where an observer moves his/her head as if the observer viewed an actual object, there is a limit to a range in which the observer can stereoscopically view the video image of the object in a proper manner.

The technique of Patent Literature 2 uses a plurality of projectors and screens. This causes a problem of upsizing the device. Moreover, since a projection system and a half mirror are used in combination, a sense of unity of a perspective perception of a three-dimensional video image is damaged. Accordingly, a distance that the observer can sense does not coincide with an actual distance. This causes the observer to be confused. That is, the observer cannot view a three-dimensional video image of an object as if the observer viewed the actual object. Note that the technique of Patent Literature 3 has a problem similar to that of the technique of Patent Literature 2.

The present invention has been made in view of the problems. According to an embodiment of the present invention, the observer can stereoscopically view a three-dimensional video image of a three-dimensional object from various angles as if the observer viewed the actual three-dimensional object from various angles.

### Solution to Problem

In order to attain the object, a display device of a first embodiment of the present invention includes: a display section which displays, based on video image data, a three-dimensional video image which is stereoscopically viewable; an acquiring section which acquires at least information indicative of a visual line direction specified when an observer observes a given position on the display section; and a generation section which (i) generates, in accordance with the information thus acquired, the video image data indicative of the three-dimensional video image which varies depending on the visual line direction and (ii) supplies the video image data thus generated to the display section.

With the configuration, the display device displays, based on the video image data, a three-dimensional video image which is stereoscopically viewable. The observer observes, in accordance with a display type of the display device, a three-dimensional video image displayed on the display section of the display device. The observer can stereoscopically view the three-dimensional video image, for example, by observing, with the naked eye, the three-dimensional video image or by observing the three-dimensional video image by wearing dedicated glasses.

The display device acquires at least information indicative of a visual line direction specified when the observer observes a given position on the display section. Note here that the given position can be, for example, a position of a center of gravity of the display section or a position of a center of the display section. Alternatively, the given position can be a position in the three-dimensional video image displayed on the display section. That is, the given position is not always limited to a position in a surface of the display section.

The display device generates, based on the information acquired, the video image data indicative of the three-dimensional video image which varies depending on the visual line direction of the observer, and then supplies the information thus generated to the display section. This allows the display section to display the three-dimensional video image which varies depending on the visual line direction of the observer, that is, the three-dimensional video image directing to the observer. In a case where the observer changes the visual line direction, the display device carries out, in real time, (i) generation of video image data and (ii) display of a three-dimensional video image which varies depending on the visual line direction so as to follow the change in visual line direction. This allows the observer to stereoscopically view the three-dimensional video image of a three-dimensional object from various angles as if the observer viewed the actual three-dimensional object from various angles.

### Advantageous Effects of Invention

As described above, the display device of the present invention is configured such that in a case where the observer changes the visual line direction, the display device carries out, in real time, (i) generation of video image data and (ii) display of a three-dimensional video image which varies depending on the visual line direction so as to follow the change in visual line direction. This allows the observer to view the three-dimensional video image of a three-dimensional object from various angles as if the observer viewed the actual three-dimensional object from various angles.

### BRIEF DESCRIPTION OF DRAWINGS

FIG. 1 is a block diagram illustrating main components of a display device of an embodiment of the present invention.

(a) and (b) of FIG. 2 are views each explaining a visual line direction and a parallax direction which are obtained in a case where a three-dimensional object is viewed from each of two different view points.

(a) of FIG. 3 is a view explaining a positional relationship, between a three-dimensional video image displayed and an observer, which is obtained in a case where the observer views the three-dimensional video image from a first view point. (b) of FIG. 3 is a view explaining a positional relationship, between the three-dimensional video image displayed and the observer, which is obtained in a case where the observer views the three-dimensional video image from a second view point which is different from the first view point.

### DESCRIPTION OF EMBODIMENTS

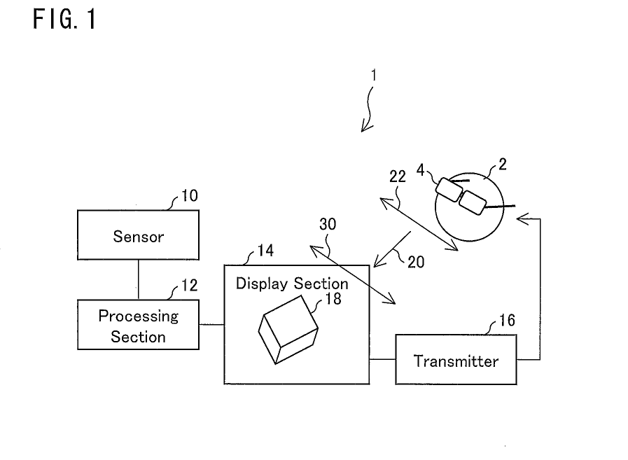

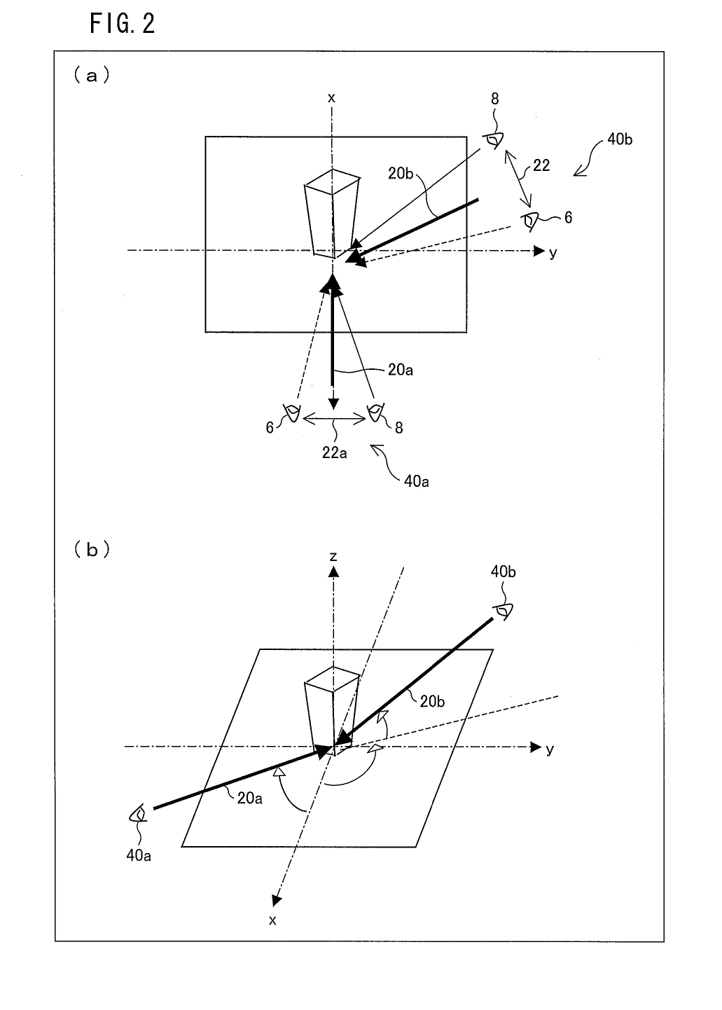

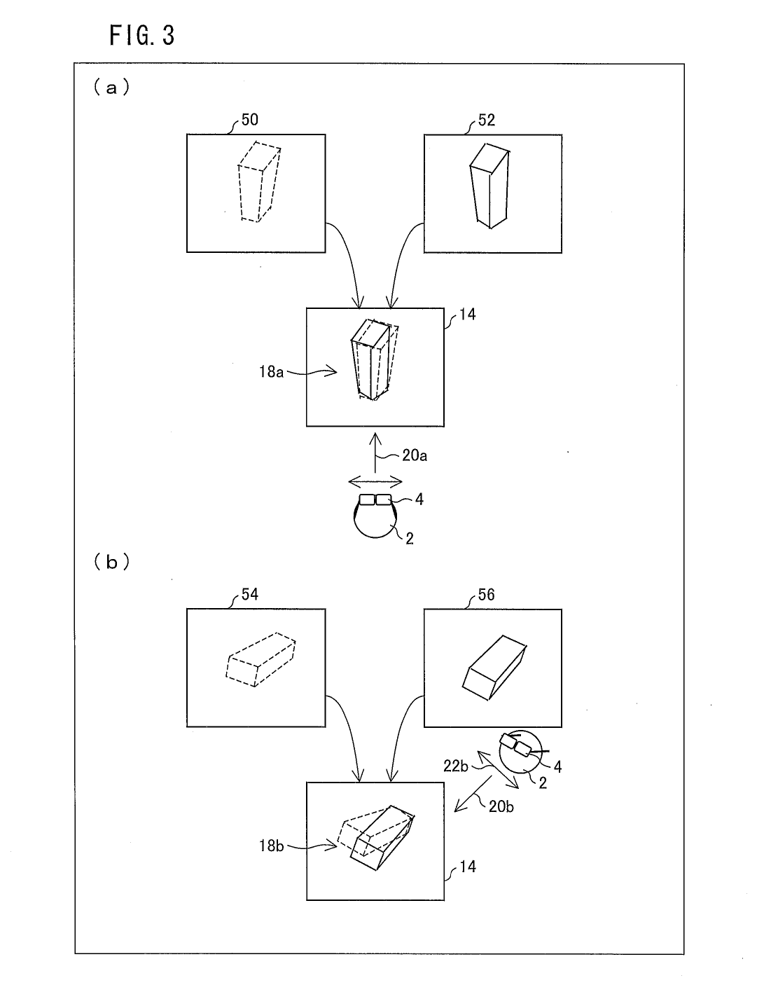

The following description will discuss an embodiment of the present invention with reference to FIGS. 1 through 3.

(Configuration of Display Device 1)

FIG. 1 is a block diagram illustrating main components of a display device 1 of an embodiment of the present invention. The display device 1 includes a sensor 10 (detection section), a processing section 12 (acquiring section, generation section), a display section 14, and a transmitter 16 (see FIG. 1).

The display device 1 is a device which displays, on the display section 14 and based on video image data, a three-dimensional video image 18 which is stereoscopically viewable. In a case where a visual line direction 20, in which an observer 2 observes the display section 14, is determined, a parallax direction 22 is simultaneously determined. While the three-dimensional video image 18, having a parallax direction 30 coincident with the parallax direction 22, is being displayed on the display section 14, the observer 2 can stereoscopically view the three-dimensional video image 18 in a proper manner.

The observer 2 observes a displayed three-dimensional video image 18 in accordance with a display type. According to the present embodiment, the observer 2 can stereoscopically view the three-dimensional video image, by wearing dedicated active shutter glasses 4 so as to observe the three-dimensional video image. The display section 14 displays the three-dimensional video image 18 by a time division system. Specifically, the display section 14 displays the three-dimensional video image 18 by switching, every given number of frames, between a left-eye video image and a right-eye video image.

The active shutter glasses 4 receive a signal which (i) is transmitted from the transmitter 16 and (ii) instructs a shutter timing. The active shutter glasses 4 then control, in accordance with such a signal, timings at which a left shutter is turned on/off and a right shutter is turned on/off.

Specifically, the active shutter glasses 4 are configured such that, in a case where the left-eye video image is displayed on the display section 14, a left-eye shutter is turned on and a right-eye shutter is turned off, whereas, in a case where the right-eye video image is displayed on the display section 14, the right-eye shutter is turned on and the left-eye shutter is turned off. This causes (i) a left eye of the observer 2 to view the left-eye video image only and (ii) a right eye of the observer 2 to view the right-eye video image only. As such, the observer 2 can stereoscopically view the three-dimensional video image 18.

(Sensor 10)

The sensor 10 acquires information indicative of at least the visual line direction 20 specified when the observer 2 observes a given position on the display section 14. Note here that the given position can be, for example, a position of a center of gravity of the display section 14 or a position of a center of the display section 14. Alternatively, the given position can be a given position in the three-dimensional video image 18 displayed on the display section 14. That is, the given position is not always limited to a position in a surface of the display section 14.

According to the display device 1, the processing section 12 acquires, from the sensor 10, information generated by the sensor 10. That is, a function of detecting the visual line direction 20 of the observer 2 is integrated in the display device 1. The processing section 12 (i) generates, based on the information acquired from the sensor 10, video image data indicative of the three-dimensional video image 18 which varies depending on the visual line direction 20 of the observer 2 and (ii) supplies, to the display section 14, the video image data thus generated. This allows the display section 14 to display the three-dimensional video image 18 which varies depending on the visual line direction 20 of the observer 2, that is, the three-dimensional video image 18 which coincides with a direction of the observer 2. Accordingly, the observer 2 can view the three-dimensional video image 18 of a three-dimensional object from various angles as if the observer viewed the actual three-dimensional object from various angles.

(Other Items Subjected to Detection)

Furthermore, the sensor 10 can (i) detect at least one of the parallax direction 22 of the observer 2, a position of the head of the observer 2, and a distance from a view point of the observer 2 to a given position and then (ii) generate information indicative of a detected result (other information). In this case, the processing section 12 (i) generates video image data based on information indicative of the parallax direction 22 of the observer 2 and information indicative of the visual line direction 20 of the observer 2 and then (ii) supplies the video image data thus generated to the display section 14. This allows the display section 14 to display a three-dimensional video image 18 which causes the observer 2 to feel more natural stereoscopic effect. Note that, as the video image is generated based on more number of types of information, the display section 14 can display the three-dimensional video image 18 which is more suitable for the observer 2. This is because it is possible to more precisely identify a relative positional relationship between the three-dimensional video image 18 and the observer 2.

Note that a method, in which the sensor 10 detects the visual line direction 20 of the observer 2 and the like, is a publicly known technique. As such, a specific description of the method is omitted here. Moreover, a method, in which the processing section 12 generates the video image data indicative of the three-dimensional video image 18 which varies depending on the visual line direction 20 of the observer 2 and the like, is also a well-known technique. A specific description of the method is therefore omitted here.

(Two Different View Points)

(a) of FIG. 2 is a view explaining a visual line direction and a parallax direction which are obtained in a case where the observer 2 views a three-dimensional object from each of two different view points. (b) of FIG. 2 illustrates a state in which the entire arrangement illustrated in (a) of FIG. 2 is rotated, by a given angle, on a center of gravity of a bottom surface of the three-dimensional object. In a case where the observer 2 observes the three-dimensional object, a given parallax occurs between a left eye 6 and a right eye 8, and a direction of the given parallax (parallax direction) is determined (see (a) and (b) of FIG. 2). For example, in a case where the observer 2 observes the three-dimensional object from a view point 40a, a parallax direction 22a, obtained by connecting the left eye 6 and the right eye 8, is determined. Furthermore, a visual line direction 20a, specified when the observer 2 observes the three-dimensional object, is determined. Meanwhile, in a case where the observer 2 observes the three-dimensional object from a view point 40b which is different from the view point 40a, a parallax direction 22b, obtained by connecting the left eye 6 and the right eye 8, is determined. Moreover, a visual line direction 20b, specified when the observer 2 observes the three-dimensional object, is determined.

(Display of Three-Dimensional Video Image 18)

The display device 1 detects, in real time, the visual line direction 20 and the parallax direction 22 of the observer 2 and the like (see (a) and (b) of FIG. 2), and then displays, on the display section 14, the three-dimensional video image 18 which varies depending on a detected result. This will be described below with reference to (a) and (b) of FIG. 3.

(a) of FIG. 3 is a view explaining a positional relationship, between a three-dimensional video image 18a displayed and the observer 2, which is obtained in a case where the observer 2 views the three-dimensional video image 18a from the view point 40a. As illustrated in (a) of FIG. 3, in a case where the observer 2 is located at the view point 40a, the display section 14 displays the three-dimensional video image 18a which varies depending on the visual line direction 20a of the observer 2. In so doing, the processing section 12 generates, based on supplied video image data, video image data containing a left-eye video image 50 and a right-eye video image 52, and then supplies the video image data thus generated to the display section 14.

The processing section 12 generates the video image data so that the three-dimensional video image 18a, which is displayed on the display section 14, is viewed in a manner similar to that in a case where the actual three-dimensional object is observed by the observer 2 from the view point 40a. More specifically, the processing section 12 calculates, based on the information acquired from the sensor 10, which part of the three-dimensional object needs to be displayed as the three-dimensional video image 18a, and then generates the video image in accordance with a calculated result.

The display section 14 displays the left-eye video image 50 and the right-eye video image 52, by switching, every given number of frames, between the left-eye video image 50 and the right-eye video image 52. The observer 2 stereoscopically views, through the active shutter glasses 4, the three-dimensional video image 18a. In this case, the observer 2 can stereoscopically view the three-dimensional video image 18a of a three-dimensional object as if the observer 2 observed the actual three-dimensional object from the view point 40a.

(Display of Three-Dimensional Video Image 18)

(b) of FIG. 3 is a view explaining a positional relationship, between a three-dimensional video image 18b displayed and the observer 2, which is obtained in a case where the observer 2 views the three-dimensional video image 18b from the view point 40b which is different from the view point 40a. As illustrated in (b) of FIG. 3, in a case where the observer 2 is located at the view point 40a, the display section 14 displays the three-dimensional video image 18b which varies depending on the visual line direction 20b of the observer 2. In so doing, the processing section 12 generates, based on supplied video image data, video image data containing a left-eye video image 54 and a right-eye video image 56, and then supplies the video image data thus generated to the display section 14.

The processing section 12 generates the video image data so that the three-dimensional video image 18b, which is displayed on the display section 14, is viewed in a manner similar to that in a case where the actual three-dimensional object is observed by the observer 2 from the view point 40b. More specifically, the processing section 12 calculates, based on the information acquired from the sensor 10, which part of the three-dimensional object needs to be displayed as the three-dimensional video image 18b, and then generates the video image in accordance with a calculated result.

The display section 14 displays the left-eye video image 54 and the right-eye video image 56, by switching, every given number of frames, between the left-eye video image 54 and the right-eye video image 56. The observer 2 stereoscopically views, through the active shutter glasses 4, the three-dimensional video image 18b. In this case, the observer 2 can observe the three-dimensional video image 18b of a three-dimensional object as if the observer 2 observed the actual three-dimensional object from the view point 40b.

As described above, the display device 1 (i) detects the visual line direction 20, the parallax direction 22 of the observer 2, and the like and then (ii) displays, on the display section 14, the three-dimensional video image 18 which varies depending on a detected result. Accordingly, a state in which the three-dimensional video image 18 is displayed changes in real time so as to follow a movement of the observer 2. That is, the display device 1 carries out, in real time, (i) detection of the visual line direction 20 and the like, (ii) generation of video image data, and (iii) display of a three-dimensional video image which varies depending on the visual line direction 20 and the like. In this case, even in a case where the observer 2 moves to any position, the display device 1 displays a three-dimensional video image 18 which causes the observer 2 to feel stereoscopic effect similar to that in a case where the observer 2 observes the actual three-dimensional object from the position. Therefore, the observer 2 can stereoscopically view the three-dimensional video image 18 of a three-dimensional object as if the observer 2 viewed the actual three-dimensional object from various angles.

The present invention is not limited to the description of the embodiments above, but may be altered by a skilled person in the art within the scope of the claims. That is, a new embodiment can be obtained from a proper combination of altered technical means within the scope of the claims.

(Position of Sensor 10)

The sensor 10 does not always need to be provided in the display device 1. The sensor 10 can be attached to the observer 2. Alternatively, the sensor 10 can be provided so as to be away from each of the display device 1 and the observer 2. That is, the sensor 10 can be provided anyplace, provided that the sensor 10 can detect the visual line direction 20 of the observer 2 and the like.

(Oxide Semiconductor)

The display section 14 preferably includes switching elements (e.g., TFT elements, etc.) each having a semiconductor layer made of oxide semiconductor. Examples of the oxide semiconductor encompass IGZO (InGaZnOx). With the configuration, the display section 14 can display a video image at a very high speed. Accordingly, even in a case where the observer 2 quickly moves, the display section 14 can smoothly change and display the three-dimensional video image 18 so as to follow the movement of the observer 2.

Alternatively, the display section 14 can include switching elements consisted by MEMS (Micro Electro Mechanical Systems). With the configuration, the display section 14 can also display a video image at a very high speed. Accordingly, even in a case where the observer 2 quickly moves, the display section 14 can smoothly change and display the three-dimensional video image 18 so as to follow the movement of the observer 2.

(Data Generation)

The processing section 12 can generate video image data indicative of a three-dimensional video image 18, by processing supplied data which originally has three-dimensional information. Alternatively, the processing section 12 can generate, based on video image data indicative of a two-dimensional video image (other video image data), video image data indicative of a three-dimensional video image 18. That is, even in a case where video image data which originally has no three-dimensional information is used, the display device 1 can display a three-dimensional video image 18.

(Type of Display Device 1)

The display device 1 is not limited to a device of specific display type. For example, in a case where the display section 14 is a liquid crystal display panel, the display device 1 can be realized as a liquid crystal display device.

(Circular Polarization Type)

In a case where the display device 1 is a liquid crystal display device, the display section 14 is preferably a liquid crystal display panel of circular polarization type. In this case, a quality of a video image is maintained at a certain level even in a case where the observer 2 views the display section 14 from any angle. Therefore, the observer 2 can observe a three-dimensional video image 18 in a certain quality regardless of a viewing angle, particularly in a case where the observer 2 wearing active shutter glasses 4 of circular polarization type observes the three-dimensional video image 18 displayed on the display section 14.

(A Plurality of Observers 2)

In a case where a plurality of observers 2, i.e., 2a and 2b, simultaneously observe a single display section 14, the display device 1 can control the display section 14 so that the plurality of observers 2 can stereoscopically view identical three-dimensional video images 18 in accordance with positions (i.e., their view points) of the respective plurality of observers 2. For example, in a case where a three-dimensional video image 18 is displayed by a time division system, the three-dimensional video image 18 which varies depending on a visual line direction of the observer 2a and the like is displayed at a timing when active shutter glasses 4 of the observer 2a are turned on, whereas the three-dimensional video image 18 which varies depending on a visual line direction of the observer 2b and the like is displayed at a timing when active shutter glasses 4 of the observer 2b are turned on.

(Space Division System)

The display section 14 can also display a three-dimensional video image 18 by a space division system. Specifically, for example, a video image is displayed in which a left-eye video image and a right-eye video image are alternated for each row (or for each column). In this case, a special configuration is formed on a display surface of the display section 14. In such a special configuration, the left-eye video image enters only a left eye and the right-eye video image enters only a right eye. Examples of such a configuration encompass a parallax barrier. This allows the observer 2 stereoscopically view, with the naked eye, the three-dimensional video image 18 in a case where the display section 14 displays the three-dimensional video image 18.

Note that the display section 14 can also display a three-dimensional video image 18 by the time division system and the space division system in combination.

(Arrangement of Display Device 1)

The display device 1 can be arranged such that a display screen is arranged approximately in parallel to a gravity direction. Alternatively, the display device 1 can be arranged such that the display screen is arranged approximately vertical to the gravity direction. In both cases, the processing section 12 carries out processing in accordance with how the display device 1 is arranged so as to generate video image data indicative of a three-dimensional video image 18 in accordance with how the display device 1 is arranged.

(Miscellaneous Descriptions)

The display device of a second embodiment of the present invention is preferably configured such that the acquiring section further acquires other information indicative of at least one of a parallax direction of the observer, a position of a head of the observer, and a distance from a view point of the observer to the given position; and the generation section generates, based on the information and the other information, the video image data.

With the configuration, it is possible to generate video image data indicative of a three-dimensional video image in which, in addition to a visual line direction of the observer, a parallax direction of the observer and the like are also taken into consideration. Accordingly, the display device can display a three-dimensional video image which causes the observer to feel more natural stereoscopic effect.

The display device of a third embodiment of the present invention is preferably configured to further include: a detection section which detects a visual line direction of the observer and generates information indicative of the visual line direction, the acquiring section acquiring the information from the detection section.

With the configuration, it is possible to realize a display device in which a function of detecting a visual line direction is integrated.

The display device of a fourth embodiment of the present invention is preferably configured such that the display section includes switching elements each having a semiconductor layer made of an oxide semiconductor.

With the configuration, the display section can display the video image at a very high speed. Accordingly, even in a case where the observer quickly moves, the display section can smoothly change and display the three-dimensional video image so as to follow the movement of the observer.

The display device of a fifth embodiment of the present invention is preferably configured such that the oxide semiconductor is IGZO.

With the configuration, the display section can display the video image at a very high speed. Accordingly, even in a case where the observer quickly moves, the display section can smoothly change and display the three-dimensional video image so as to follow the movement of the observer.

The display device of a sixth embodiment of the present invention is preferably configured such that the display section includes switching elements each constituted by MEMS.

With the configuration, the display section can display the video image at a very high speed. Accordingly, even in a case where the observer quickly moves, the display section can smoothly change and display the three-dimensional video image so as to follow the movement of the observer.

The display device of a seventh embodiment of the present invention is preferably configured such that the generation section generates, based on other video image data indicative of a two-dimensional video image, the video image data indicative of the three-dimensional video image.

With the configuration, even in a case where video image data which originally has no three-dimensional information is used, the three-dimensional video image can be displayed.

The display device of an eighth embodiment of the present invention is preferably configured such that the display section is a liquid crystal display panel.

With the configuration, it is possible to realize the display device as a liquid crystal display device.

The display device of a ninth embodiment of the present invention is preferably configured such that the display section is a liquid crystal display panel of circular polarization type.

With the configuration, a quality of a video image is maintained at a certain level even in a case where the display section is viewed from any angles. Therefore, the observer can observe a three-dimensional video image in a certain quality regardless of a viewing angle, particularly in a case where the observer wearing active shutter glasses of circular polarization type observes the three-dimensional video image displayed on the display section.

### INDUSTRIAL APPLICABILITY

The display device of the present invention can be widely employed as a device capable of displaying a three-dimensional video image which can be stereoscopically viewed. For example, the display device of the present invention is potentially employed as a display device for use in a television device or a game machine.

### REFERENCE SIGNS LIST

1: Display device

2: Observer

4: Active shutter glasses

10: Sensor (detection section)

12: Processing section (acquiring section, generation section)

14: Display section

16: Transmitter

18: Three-dimensional video image

1. A display device comprising:
a display section which displays, based on video image data, a three-dimensional video image which is stereoscopically viewable;
an acquiring section which acquires at least information indicative of a visual line direction specified when an observer observes a given position on the display section; and
a generation section which (i) generates, in accordance with the information thus acquired, the video image data indicative of the three-dimensional video image which varies depending on the visual line direction and (ii) supplies the video image data thus generated to the display section.

2. The display device as set forth in claim 1, wherein:
the acquiring section further acquires other information indicative of at least one of a parallax direction of the observer, a position of a head of the observer, and a distance from a view point of the observer to the given position; and
the generation section generates, based on the information and the other information, the video image data.

3. A display device as set forth in claim 1, further comprising:
a detection section which detects a visual line direction of the observer and generates information indicative of the visual line direction,
the acquiring section acquiring the information from the detection section.

4. The display device as set forth in claim 1, wherein the display section includes switching elements each having a semiconductor layer made of an oxide semiconductor.

5. The display device as set forth in claim 4, wherein the oxide semiconductor is IGZO.

6. The display device as set forth in claim 1, wherein the display section includes switching elements each constituted by MEMS.

7. The display device as set forth in claim 1, wherein the generation section generates, based on other video image data indicative of a two-dimensional video image, the video image data indicative of the three-dimensional video image.

8. The display device as set forth in claim 1, wherein the display section is a liquid crystal display panel.

9. The display device as set forth in claim 8, wherein the display section is a liquid crystal display panel of circular polarization type.

10. The display device as set forth in claim 1, further comprising:
a detection section which detects a visual line direction of the observer and generates information indicative of the visual line direction,
the acquiring section acquiring (a) the information from the detection section and (b) other information indicative of at least one of a parallax direction of the observer, a position of a head of the observer, and a distance from a view point of the observer to the given position,
the generation section generating, based on the information and the other information, the video image data,
the display section including switching elements each having a semiconductor layer made of oxide semiconductor.
